(19) United States
(12) Patent Application Publication
(10) Pub. No.: US 2011/0218105 A1
(43) Pub. Date: Sep. 8, 2011

(54) PRE-PLANT OR PRE-EMERGENT HERBICIDE COMPOSITIONS

(76) Inventor: Larry Walker, Flintville, TN (US)

(21) Appl. No.: 12/716,975

(22) Filed: Mar. 3, 2010

(51) Int. Cl. A01N 43/70; A01P 13/00

(52) U.S. Cl. 504/134; 504/133

(57) ABSTRACT

An herbicide composition for use in crop production including an herbicidally effective amount of ametryn and topramezone prepared for application to soil prior to emergence of crops; the application of ametryn and topramezone having a weight ratio of about 39:1 to about 150:1 of ametryn to topramezone as applied to the locus.

A portion of the disclosure of this patent document contains material that is subject to copyright protection. The copyright owner has no objection to the reproduction of the patent document or the patent disclosure, as it appears in the U.S. Patent and Trademark Office patent file or records, but otherwise reserves all copyright rights whatsoever.

### CROSS-REFERENCES TO RELATED APPLICATIONS

This application claims benefit of the following patent application(s) which is/are hereby incorporated by reference: None

### STATEMENT REGARDING FEDERALLY SPONSORED RESEARCH OR DEVELOPMENT

Not Applicable

### REFERENCE TO SEQUENCE LISTING OR COMPUTER PROGRAM LISTING APPENDIX

Not Applicable

### BACKGROUND OF THE INVENTION

The present invention relates to herbicide compositions and methods of controlling weeds with a herbicidally effective amount of ametryn and topramezone. More particularly, the present invention includes herbicide compositions which are applied prior to the emergence of the target plant species from the soil.

Herbicides have become a necessary component in the growth of crops as weeds can often grow much quicker and create undesirable competition to the desired plants. The investigation for compounds which have both an excellent herbicidal activity towards target weeds and also a relatively low toxicity toward crops or non-target weeds is continuing as the specific application of various herbicides is an evolving process.

Herbicides such as Roundup® have been applied for decades and are characterized as broad spectrum herbicides that contain glyphosate. Generally, glyphosate herbicides may be used to kill weeds and are sprayed and absorbed through the leaves of the weeds, the herbicides functioning by inhibiting enzymes necessary for the plants to synthesize certain amino acids. For many years, glyphosate herbicides have been the predominant type of herbicides utilized for agricultural, horticultural and silvicultural purposes and further are often utilized for homeowners' gardens in non selective weed control.

Glyphosate herbicides generally understood to be non-selective burndown herbicides and not pre-emergent residual herbicides as the glyphosate herbicides are only effective on actively growing plants with the requirement that the application of the herbicides be timed so that the herbicides do not wash away from the soil or alternatively fail to inhibit the enzymes when applied late in the weeds' growth cycle. The repetitive use of glyphosate herbicides, including using glyphosate for multiple applications in a single year, spanning over multiple decades, has led to glyphosate resistant weeds becoming more prevalent, particularly across the corn belt of the United States.

What is desired, therefore, are non-glyphosate herbicides for breaking the cycle of glyphosate applications and to expose weeds and grasses to a different type of herbicides while providing residual weed and grass control in crop production so as to reduce or eliminate multiple applications of glyphosate, both in burndown and post applications in the production of crops. Indeed, an herbicide composition having a combination of characteristics, including the capacity to be applied as a pre-plant or pre-emergent herbicide, provides an advantageous alternative to traditional glyphosate herbicides used in agricultural purposes. Also desired is a method of applying non-glyphosate herbicide compositions to a locus in a pre-plant or pre-emergent manner.

### BRIEF SUMMARY OF THE INVENTION

One embodiment of the present invention provides a herbicidally effective amount of ametryn and topramezone that is applied to the soil prior to the emergence of the target plant from the soil. As used herein “herbicide” is defined as a substance used to control or destroy plants which may include weeds, grasses, brush or other undesired plants. Furthermore, “pre-plant” as used in association with herbicides is defined as applied prior to planting the desired crop or type of plant. “Pre-emergent” may be used synonymously with “pre-emergence” and is used in reference to herbicides for the control of a target plant prior to the target plant emerging from the soil.

Additionally, in further optional embodiments, the invention may be applied to existing weeds and grasses in the field for weed & grass control to allow the grower to plant on a stale seedbed. “Target plant” is defined as the primary plant that the herbicide intended to control the growth thereof or destroy. Also, as used herein, the term “active ingredient” is defined as the chemical compound or compounds responsible for the control or the toxicity of the target plant.

Generally, pre-plant and pre-emergent herbicides are differentiated from post-emergent herbicides as pre-plant and pre-emergent herbicides often function through disrupting the germination of target plants or other metabolic pathways whereas post-emergent herbicides are applied to plants that have emerged from the soil.

Ametryn, a component of an herbicide composition of the present invention, may be generally understood to be an asymmetric triazine. Other embodiments of the invention may include the use of ametryn in a pre-emergent or pre-plant herbicide with ametryn being applied to the soil at less than about 600 grams per acre of soil.

Topramezone, as an additional component of the present invention, may be combined with ametryn for application to the soil prior to the emergence of crops. Topramezone is generally understood to be a hydroxyl phenyl pyruvate dioxygenase (HPPD) inhibitor that disrupts the synthesis of carotene pigments.

Advantageously, the mode of action of ametryn can be described as a photosynthesis inhibitor where inhibition occurs at the photosystem II receptor site which may be considered complementary to topramezone's mode of action of carotenoid disruption. The combination of topramezone and ametryn may be useful as an herbicide combination for many common weed and grass species including but not limited to marestail, smartweed, ragweed, pigweeds and amaranths, cocklebur, lambsquarter, morning glory, crabgrass, foxtail, panicum, goosegrass, wild proso millet, and combinations thereof.

One object of the invention, therefore, is a combination of ametryn and topramezone applied to soil prior to the emergence of target plants.

An additional optional object of the invention is a combination of ametryn and topramezone applied to soil prior to the planting of a desired plant which may include one or more crops. Embodiments of the invention may be from about 50 days prior to planting of the crop or crops to about 3 days after the crop or crops have been planted. The herbicide composition is generally applied prior to the emergence of corn from the soil.

Another object of the invention is a method for reducing the growth of weeds in soil during crop production through the application of a combination of ametryn and topramezone to the soil prior to the emergence of target weeds or at the planting of crops and prior to crop emergence.

These aspects and others that become apparent to those of skill in the art upon review of the following description can be accomplished by ametryn and topramezone and applying to a locus with the weight ratio of ametryn to topramezone optionally being in the range of about 39:1 to about 150:1 in application prior to the emergence of crops. Optional embodiments of the present invention may further include additional components ranging from further herbicides to concentrated crop oil.

It is to be understood that both the foregoing general description and the following detailed description provide embodiments of the invention and are intended to provide an overview or framework of understanding to nature and character of the invention as it is claimed.

### DETAILED DESCRIPTION OF THE INVENTION

Herbicide compositions in accordance with the present invention are prepared from ametryn and topramezone for application to a locus for one or more crops prior to the emergence of the crops from the soil.

Ametryn has an IUPAC name of N²-ethyl-N⁴-isopropyl-6-methylthio-1,3,5-triazine-2,4-diamine and the following formula:

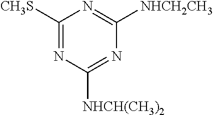

In some optional embodiments, ametryn also includes an agronomically accessible salt thereof which may include an acid addition such as a sulfate or phosphate and the like. Ametryn is often formulated in about an 80% active ingredient solution or mixture and for purposes of the disclosure any reference to the amount, percent, or ratio of ametryn refers to ametryn as an active ingredient unless otherwise stated.

Topramezone has an IUPAC name of [3-(4,5-dihydro-1,2-oxazol-3-yl)-4-mesyl-o-tolyl](5-hydroxy-1-methylpyraz-of-4-yl)methanone and the following formula:

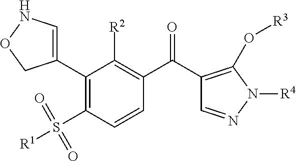

In further optional embodiments topramezone and derivatives thereof may include a compound having the following formula, where:

R¹ is C₁₋₆ alkyl;

R² is hydrogen or C₁₋₆ alkyl;

R³ is hydrogen or C₁₋₆ alkyl;

R⁴ is hydrogen or C₁₋₆ alkyl.

Additionally, the use of the term topramezone also includes acceptable salts thereof and any discussion as to the amount, percentage, ratio or weight refers to topramezone as the active ingredient unless otherwise stated.

Ametryn and topramezone may be tank-mixed together or applied in separate steps prior to the emergence of weeds from the soil. As used herein the term “herbicidally effective amount” refers to the amount of one or more herbicides suitable for providing an adverse effect on the growth of the target plant.

An herbicide composition having both ametryn and topramezone generally includes a weight ratio of ametryn to topramezone of about 39:1 to about 150:1. In some optional embodiments the ratio of the herbicidal composition may have a weight ratio of ametryn to topramezone of about 39:1 to about 120:1.

Ametryn may be applied per acre of soil in an amount from about 290 grams to about 600 grams of ametryn per acre and in further optional embodiments in an amount less than about 480 grams of ametryn per acre of soil. Topramezone, applied with the composition as a pre-plant or pre-emergent herbicide, may be applied to the soil in an amount from about 4 grams to about 7.4 grams per acre.

In optional embodiments of the present invention, the herbicide composition may be applied between about 50 days prior to planting of the crop or crops and up to about 3 days after the crop or crops have been planted. Additionally, application of the herbicides compositions should occur prior to the emergence of the crops from the soil.

Other elements may be included within a composition having both ametryn and topramezone with the additional elements optionally comprising herbicides. One such herbicide that may be combined with ametryn and topramezone is atrazine which inhibits electron transport within photo system II of broad leaf and grassy weeds. Atrazine has an IUPAC name 6-chloro-N²-ethyl-N⁴-isopropyl-1,3,5-triazine-2,4-diamine with the following formula:

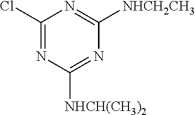

Atrazine, also including salts thereof, is an often used as a pre-emergent herbicide for grassy weeds and is commonly used in the growing of corn. Mixtures including atrazine may include atrazine at concentration of around 40%. In combining atrazine with ametryn and topramezone to form optional herbicide composition embodiments, atrazine may comprise from about 25% to about 65% of the active ingredients within the herbicide composition. Optional embodiments of an herbicide composition may comprise about 30 to about 65% active ingredient ametryn; about 0.4 to about 1.3% active ingredient topramezone and about 25 to about 65% active ingredient atrazine.

In further optional embodiments, additional herbicides may include metolachlor which is often produced under the commercial name Dual Magnum. Metolachlor is considered to be effective toward grasses and inhibits enzymes of plants' tibberellin pathways. Metolachlor has the IUPAC name 2-Chloro-N-(2-ethyl-6-methyl-phenyl)-N-(1-methoxypropan-2-yl)acetamide and is described by the general formula:

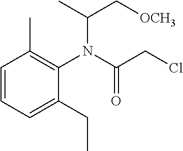

Optional embodiments of herbicide compositions of the present invention may include metolachlor present in an amount of about 15% to about 35% of the total active ingredients of an herbicide composition including both ametryn and topramezone. Further optional embodiments of herbicidal compositions include ametryn at about 30% to about 65% of the total active ingredients; topramezone from about 0.4% to about 13.0% of the total active ingredients; atrazine from about 25% to about 65% of the total active ingredients, and metolachlor from about 15% to about 35% of the total active ingredients of an herbicide composition.

The herbicidally active ingredients alone or together with the other ingredients may be applied to a locus simultaneously or sequentially in any desired order. In further optional embodiments, the herbicide composition may be applied as a take-mix where the ingredients are mixed together prior to application to the locus for the control of the target plants. The herbicide is considered a pre-emergent herbicide composition when it is applied prior to the emergence of the target plants and alternatively may be considered a pre-plant herbicide composition application when the herbicide composition is administered to the locus prior to the planting of a crop. Embodiments of the present invention where the herbicide composition is applied as a pre-emergent herbicide composition may involve the administration of the composition to the locus under cultivation after the soil has been sown but yet not sustained vegetation.

The herbicide composition of the present invention may optionally embody a variety of different formulations including powders which may include water soluble powders and wettable powders, concentrations which may include water soluble concentrations and emulsifiable concentrations and further may include oil containing mixtures such as water and oil emulsions. The herbicide composition may in additional optional embodiments include sprayable solutions which may be a variety of liquid solutions and dispersions. Other formulations may include oil miscible solutions, suspended concentrations or relatively dry mixtures such as granules which may be sprayed, coated or simply distributed upon the soil.

Compositions may additionally include oils such as crop oil concentrates such as vegetable or petroleum oil or both. Other types of crop oil concentrates that may be utilized in optional embodiments of the present invention may include vegetable oils such as soybean, sunflower, cotton, canola, seed oils or combinations thereof or additionally petroleum oil which may be emulsifiable.

The herbicidal composition may also include surfactants to assist in the dispersion and wetting properties of the herbicidal composition and may include up to about 20% surfactant. Advantageously, the use of crop oil concentrate may enhance herbicide activity thus possibly requiring less of an herbicide composition to be required for maintaining control or destroying the target plants.

Optional embodiments of herbicidal composition of the present invention may be utilized in the growth of crops which may include corn. Target plants that may be controlled by the use of the herbicide composition may include Conyga canadensis also known as horseweed, Canadian horseweed, Canadian fleabane, coltstail, marestail and butterweed; Ambrosia also referred to ragweeds, bitterweeds or bloodweeds; pigweed which may include Amaranthus species, some of which are resistant to glyphosate; Xanthium also known as cockleburs; Chenopodium species also known as white goosefoot, lambsquarters, nickel greens, dungweed or goosefoot; morning glory which may include species belonging to Calystetia, Convolvulus, Ipomoea, Merremia, Rivea, Astripomoea, Operculina, Stictocardia, Argyreia and Lepistemon; Digitaria species which may be referred to as crabgrass, finger-grass and fonio; foxtails which may include species of Alopecurus, Bromus, Hordeum, Setaria, Acalypha, Lycopodium, Wodyetia; Panicum species; Galium aparine which may be referred to as cleavers, goosegrass, sticky willy, stickyweed, catchweed, robin-run-the-hedge and coachweed; proso millet also known as common millet, broomcorn, hog millet or white millet and combinations thereof.

In order to further illustrate the principles and operation of the present invention, the following examples are provided. However, the examples should not be considered as limiting in any regard.

In the following examples, combinations of herbicidal compositions are applied to separate one-acre plots. One pint of crop oil concentrate is administered with the herbicides used to formulate each of the below compositions. Ametryn is formulated at about an 80% concentration of active ingredient (referred to as about 80% ametryn). Topramezone is provided through the application of Impact®, an herbicide containing about 30% topramezone, with about 2.8 pounds topramezone per gallon of Impact®. Any other herbicides are provided by their trade names and are used as listed in the following examples.

Examples 1-5 are summarized in Table 1 below which provides the percentage of corn phytotoxicity and the percentage control of marestail, pigweed, and annual grass.

TABLE 1
Herbicide application at planting or up to 3 days later

| Herbicide | Marestail | Pigweed | Annual Grass | Crop |
|---|---|---|---|---|
| Treatment | % Control | % Control | % Control | % Phyto |
| 1 lb Ametryn 80 | 100% | 97% | 94% | <2% |
| .6 oz Impact | | | | |
| 1 ½ pt Atrazine 4 | | | | |
| 1 lb Ametryn 80 | 100% | 98% | 98% | <2% |
| .6 oz Impact | | | | |
| 1 1/2 pts Atrazine 4 | | | | |
| 8 oz Dual Mag | | | | |
| 3 pts Atrazine 4 | 94% | 88% | 86% | <2% |
| 1 ½ lbs Ametryn | 100% | 98% | 94% | <2% |
| 80 | | | | |
| 1 ½ pts Atrazine 4 | | | | |
| .75 oz Impact | 100% | 97% | 94% | <2% |
| 1 ½ pts Atrazine 4 | | | | |

### Example 1

One pound of about 80% ametryn, about 0.6 ounces of Impact®, and about 12 ounces of Atrazine 4L are applied to one acre of prepared land at about the same time corn is planted or up to about three days after the crop is planted. Monitored values include the control of marestail, pigweed, and annual grass as well as corn phytotoxicity with measurements to be taken after approximately five weeks. The following values are realized for each of the monitored values at about five weeks:

a. 100% Control of Marestail

b. 97% Control of Pigweed

c. 94% Control of Annual Grass

d. <2% Corn Phytotoxicity

### Example 2

One pound of about 80% ametryn, about 0.6 ounces of Impact®, about 12 ounces of Atrazine 4L and about 8 ounces of Dual Magnum® are applied to one acre of prepared land at about the same time corn is planted or up to about three days after the crop is planted. Monitored values include the control of marestail, pigweed, and annual grass as well as corn phytotoxicity with measurements to be taken after approximately five weeks. The following values are realized for each of the monitored values at about five weeks:

a. 100% Control of Marestail

b. 98% Control of Pigweed

c. 98% Control of Annual Grass

d. <2% Corn Phytotoxicity

### Example 3

Three pints of Atrazine 4L are applied to one acre of prepared land at about the same time corn is planted or up to about three days after the crop is planted. Monitored values include the control of marestail, pigweed, and annual grass as well as corn phytotoxicity with measurements to be taken after approximately five weeks. The following values are realized for each of the monitored values at about five weeks:

a. 94% Control of Marestail

b. 88% Control of Pigweed

c. 86% Control of Annual Grass

d. <2% Corn Phytotoxicity

### Example 4

One and one half pounds of about 80% ametryn and about 12 ounces of Atrazine 4L are applied to one acre of prepared land at about the same time corn is planted or up to about three days after the crop is planted. Monitored values include the control of marestail, pigweed, and annual grass as well as corn phytotoxicity with measurements to be taken after approximately five weeks. The following values are realized for each of the monitored values at about five weeks:

a. 100% Control of Marestail

b. 98% Control of Pigweed

c. 94% Control of Annual Grass

d. <2% Corn Phytotoxicity

### Example 5

About 0.75 ounces of Impact®, and about 12 ounces of Atrazine 4L are applied to one acre of prepared land at about the same time corn is planted or up to about three days after the crop is planted. Monitored values include the control of marestail, pigweed, and annual grass as well as corn phytotoxicity with measurements to be taken after approximately five weeks. The following values are realized for each of the monitored values at about five weeks:

a. 100% Control of Marestail

b. 97% Control of Pigweed

c. 94% Control of Annual Grass

d. <2% Corn Phytotoxicity

Examples 6-11 are summarized in Table 2 below which provides the percentage of corn phytotoxicity and the percentage control of marestail, pigweed, and annual grass.

TABLE 2
Herbicide application approximately two weeks prior to planting

| Herbicide | Marestail | Pigweed | Annual Grass | % Corn |
|---|---|---|---|---|
| Treatment | % Control | % Control | % Control | Phyto |
| 1 lb Ametryn 80 | 98% | 96% | 95% | <2% |
| .6 oz Impact | | | | |
| 1 ½ pts Atrazine 4L | | | | |
| 1 lb Ametryn 80 | 98% | 93% | 99% | <2% |
| .6 oz Impact | | | | |
| 1 ½ pts Atrazine 4L | | | | |
| 8 oz Dual Magnum | | | | |
| 8 oz Clarity 4 | 96% | 87% | 91% | <2% |
| 2 pts Roundup 4 | | | | |
| 2 qts Atrazine 4L | | | | |
| 1 ½ lbs Ametryn 80 | 98% | 97% | 95% | <2% |
| .75 oz Impact | | | | |
| 1 ½ pts Atrazine 4 | | | | |
| 1 ½ lbs Ametryn 80 | 98% | 96% | 94% | <2% |
| 4 oz Clarity | | | | |
| .75 oz Impact | 96% | 96% | 84% | <2% |
| 4 oz Clarity | | | | |

### Example 6

One pound of about 80% ametryn, about 0.6 ounces of Impact®, and about 12 ounces of Atrazine 4L are applied to one acre of land approximately two weeks prior to planting corn on the acre. Monitored values include the control of marestail, pigweed, and annual grass as well as corn phytotoxicity with measurements to be taken after approximately seven weeks. The following percentages are realized for each of the monitored values at about seven weeks:

a. 98% Control of Marestail

b. 96% Control of Pigweed

c. 95% Control of Annual Grass

d. <2% Corn Phytotoxicity

### Example 7

One pound of about 80% ametryn, about 0.6 ounces of Impact®, about 12 ounces of Atrazine 4L and about 9 ounces of Dual Magnum® are applied to one acre of land approximately two weeks prior to planting corn on the acre. Monitored values include the control of marestail, pigweed, and annual grass as well as corn phytotoxicity with measurements to be taken after approximately seven weeks. The following percentages are realized for each of the monitored values at about seven weeks:

a. 98% Control of Marestail

b. 93% Control of Pigweed

c. 99% Control of Annual Grass

d. <2% Corn Phytotoxicity

### Example 8

About 8 ounces of Clarity®, about 0.6 ounces of Impact®, about 16 ounces of Roundup® and about 64 ounces of Atrazine 4L are applied to one acre of land approximately two weeks prior to planting corn on the acre. Monitored values include the control of marestail, pigweed, and annual grass as well as corn phytotoxicity with measurements to be taken after approximately seven weeks. The following percentages are realized for each of the monitored values at about seven weeks:

a. 98% Control of Marestail

b. 93% Control of Pigweed

c. 99% Control of Annual Grass

d. <2% Corn Phytotoxicity

### Example 9

One and one half pounds of about 80% ametryn, about 0.75 ounces of Impact®, and about 12 ounces of Atrazine 4L are applied to one acre of land approximately two weeks prior to planting corn on the acre. Monitored values include the control of marestail, pigweed, and annual grass as well as corn phytotoxicity with measurements to be taken after approximately seven weeks. The following percentages are realized for each of the monitored values at about seven weeks:

a. 98% Control of Marestail

b. 96% Control of Pigweed

c. 95% Control of Annual Grass

d. <2% Corn Phytotoxicity

### Example 10

One and one half pounds of about 80% ametryn, and about 4 ounces of Clarity® are applied to one acre of land approximately two weeks prior to planting corn on the acre. Monitored values include the control of marestail, pigweed, and annual grass as well as corn phytotoxicity with measurements to be taken after approximately seven weeks. The following percentages are realized for each of the monitored values at about seven weeks:

a. 98% Control of Marestail

b. 96% Control of Pigweed

c. 94% Control of Annual Grass

d. <2% Corn Phytotoxicity

### Example 11

About 0.75 ounces of Impact®, and about 4 ounces of Clarity® are applied to one acre of land approximately two weeks prior to planting corn on the acre. Monitored values include the control of marestail, pigweed, and annual grass as well as corn phytotoxicity with measurements to be taken after approximately seven weeks. The following percentages are realized for each of the monitored values at about seven weeks:

a. 96% Control of Marestail

b. 96% Control of Pigweed

c. 84% Control of Annual Grass

d. <2% Corn Phytotoxicity

Accordingly, by the practice of the present invention, herbicide compositions having heretofore unrecognized characteristics are prepared. These herbicides exhibit exceptionally control of common weeds, especially in the growing of corn and are used in either a pre-plant or pre-herbicide application. Advantageously, the herbicide compositions can be used where weeds have become resistant to glyphosate herbicides.

The above description is intended to enable the person skilled in the art to practice the invention. It is not intended to detail all of the possible variations and modifications that will become apparent to the skilled worker upon reading the description. It is intended, however, that all such modifications and variations be included within the scope of the invention that is defined by the following claims. The claims are intended to cover the indicated elements and steps in any arrangement or sequence that is effective to meet the objectives intended for the invention, unless the context specifically indicates the contrary.

Thus, although there have been described particular optional embodiments of the present invention of a new and useful pre-plant or pre-emergent herbicide compositions, which can be applied at or after planting, it is not intended that such references be construed as limitations upon the scope of this invention except as set forth in the following claims.

What is claimed is:

1. An herbicide composition for use in crop production comprising:
an herbicidally effective amount of ametryn and topramezone prepared for application to soil prior to emergence of crops.

2. The herbicide composition of claim 1 wherein the ametryn and topramezone have a weight ratio of ametryn to topramezone of from about 39:1 to about 150:1.

3. The herbicide composition of claim 1 wherein the combination is prepared for application at less than about 600 grams ametryn per acre of soil.

4. The herbicide composition of claim 1 further comprising an S-metolachlor composition.

5. The herbicide composition of claim 1 further comprising an atrazine composition.

6. The herbicide composition of claim 1 wherein the herbicidally effective amount of ametryn and topramezone comprises a pre-plant herbicide.

7. The herbicide composition of claim 1 wherein the herbicidally effective amount of ametryn and topramezone comprises a pre-emergent herbicide.

8. The herbicide composition of claim 1 wherein the composition further comprises an oil.

9. An herbicide composition for use in crop production comprising an active ingredient having
about 30 percent to about 65 percent ametryn;
about 0.4 percent to about 1.3 percent topramezone; and
about 25 percent to about 65 percent atrazine.

10. A method for reducing the growth of weeds in soil during crop production comprising applying a combination of ametryn and topramezone to the soil prior to the emergence of crops.

11. A method for controlling the growth of weeds at a locus for one or more crops which comprising the step of applying to said locus a photosynthesis inhibiting herbicide, or an agriculturally acceptable salt or metal complex thereof, and a 4-hydroxyphenyl-pyruvate-dioxygenase inhibiting herbicide, or an agriculturally acceptable salt or metal complex thereof.

12. The method of claim 9 wherein the photosynthesis inhibiting herbicide comprises ametryn, which is N²-ethyl-N⁴-isopropyl-6-methylthio-1,3,5-triazine-2,4-diamine and the 4-hydroxyphenyl-pyruvate-dioxygenase inhibiting herbicide comprises topramezone, which is [3-(4,5-dihydro-1,2-oxazol-3-yl)-4-mesyl-o-tolyl](5-hydroxy-1-methylpyrazol-4-yl)methanone.

13. The method of claim 12 wherein the ametryn is applied at a rate of about 290 grams per acre to about 600 grams per acre.

14. The method of claim 13 wherein the topramezone is applied at a rate of about 4 grams per acre to about 7.4 grams per acre.

15. The method of claim 12 wherein the ametryn and topramezone are applied at a ratio of about 39:1 to about 150:1 of ametryn to topramezone.

16. The method of claim 12 wherein the herbicide is applied to weeds selected from the group consisting of marestail, smartweed, ragweed, pigweeds, amaranthus, cocklebur, lambsquarter, morning glory, crabgrass, foxtail, panicum, goosegrass, wild proso millet and combinations thereof.

17. The method of claim 12 wherein the step of applying ametryn and topramezone further comprises applying ametryn and topramezone as a pre-emergent herbicide.

18. The method of claim 12 wherein the step of applying ametryn and topramezone further comprises applying ametryn and topramezone as a pre-plant herbicide.

19. The method of claim 12 wherein the step of applying ametryn and topramezone further comprises applying the ametryn and topramezone about fourteen days prior to planting the one or more crops.

20. The method of claim 12 further comprising applying the ametryn and topramezone with about one pint of crop oil concentrate per acre.
